(19) United States
(12) Patent Application Publication
(10) Pub. No.: US 2024/0292408 A1
(43) Pub. Date: Aug. 29, 2024

(54) SIMULTANEOUS SR PUCCH AND UCI ON PUSCH WITH PARTIAL DROPPING

(71) Applicant: SHARP KABUSHIKI KAISHA, Sakai City, Osaka (JP)

(72) Inventors: ZHANPING YIN, Vancouver, WA (US); KAI YING, Vancouver, WA (US)

(21) Appl. No.: 18/570,235

(22) PCT Filed: Jun. 23, 2022
(86) PCT No.: PCT/JP2022/025022

§ 371 Date: Dec. 14, 2023

Related U.S. Application Data
(60) Provisional application No. 63/217,251, filed on Jun. 30, 2021.

(51) Int. Cl. H04W 72/1268; H04L 1/1829; H04W 72/21; H04W 72/566

(52) U.S. Cl. CPC H04W 72/1268; H04L 1/1854; H04W 72/21; H04W 72/566

(57) ABSTRACT

A user equipment (UE) is described. The UE includes transmitting circuitry. The transmitting circuitry is configured to report a high-priority positive scheduling request (SR) and uplink control information (UCI) based on an overlapping condition. The high-priority positive SR and the UCI are multiplexed on a physical uplink shared channel (PUSCH).

### CROSS REFERENCE

This Nonprovisional application claims priority under 35 U.S.C. § 119 on provisional Application No. 63/217,251 on Jun. 30, 2021, the entire contents of which are hereby incorporated by reference.

### TECHNICAL FIELD

The present disclosure relates generally to communication systems. More specifically, the present disclosure relates to simultaneous scheduling request (SR) physical uplink control channel (PUCCH) and uplink control information (UCI) on physical uplink shared channel (PUSCH) with partial dropping.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE), comprising: transmitting circuitry configured to report a high-priority positive scheduling request (SR) and uplink control information (UCI) multiplexed on a physical uplink shared channel (PUSCH) based on an overlapping condition.

In one example, a base station (gNB), comprising: transmitting circuitry configured to transmit higher-layer signaling to a user equipment (UE), wherein the higher-layer signaling indicates a configuration of a channel dropping procedure with potential simultaneous SR physical uplink control channel (PUCCH) and UCI reporting on the PUSCH.

In one example, a method by a user equipment (UEL), comprising: reporting a high-priority positive scheduling request (SR) and uplink control information (UCI) multiplexed on a physical uplink shared channel (PUSCH) based on an overlapping condition.

### BRIEF DESCRIPTION OF DRAWINGS

FIG. 1 is a block diagram illustrating one implementation of one or more gNBs 160 and one or more UEs 102 in which systems and methods for channel dropping behaviors may be implemented.

FIG. 2 is a block diagram illustrating one implementation of a gNB.

FIG. 3 is a block diagram illustrating one implementation of a UE.

FIG. 4 illustrates various components that may be utilized in a UE.

FIG. 5 illustrates various components that may be utilized in a gNB.

FIG. 6 is a block diagram illustrating one implementation of a UE in which the systems and methods described herein may be implemented.

FIG. 7 is a block diagram illustrating one implementation of a gNB in which the systems and methods described herein may be implemented.

FIG. 8 is a flow diagram illustrating a method by a UE for handling SR and PUSCH collision.

FIG. 9 is a flow diagram illustrating another method by a UE for handling SR and PUSCH collision.

FIG. 10 is a flow diagram illustrating a method by a UE for reporting both LP UCI on PUSCH and HP SR in overlapping conditions.

FIG. 11 is a flow diagram illustrating a method by a UE for reporting multiple LP UCIs on PUSCH and HP SR by overlapping conditions.

FIG. 12 is a flow diagram illustrating a method by a UE for reporting both HP UCI on a PUSCH and HP SR by overlapping conditions.

FIG. 13 is a flow diagram illustrating a method by a UE for reporting both HP and LP UCI on a PUSCH and HP SR by overlapping conditions.

FIG. 14A is a diagram illustrating a first example of puncturing in accordance with some of the techniques described herein.

FIG. 14B is a diagram illustrating a second example of puncturing in accordance with some of the techniques described herein.

FIG. 14C is a diagram illustrating a third example of puncturing in accordance with some of the techniques described herein.

FIG. 14D is a diagram illustrating a fourth example of puncturing in accordance with some of the techniques described herein.

FIG. 14E is a diagram illustrating a fifth example of puncturing in accordance with some of the techniques described herein.

### DESCRIPTION OF EMBODIMENTS

A user equipment (UE) is described. The UE includes a processor configured to determine a channel dropping behavior based on a priority of uplink control information (UCI) multiplexed on a physical uplink shared channel (PUSCH). The UE also includes transmitting circuitry. The transmitting circuitry is configured to, if a physical uplink control channel (PUCCH) for a positive scheduling request (SR) with priority index 1 overlaps with the PUSCH with a priority index 0, and if there is no UCI or only low-priority UCI is multiplexed on the PUSCH, transmit the PUCCH with the positive high-priority SR and cancel transmission of the PUSCH. Or, the transmitting circuitry is configured to, if the PUCCH for the positive SR with the priority index 1 overlaps with the PUSCH with the priority index 0, and if there is at least a high-priority UCI multiplexed on the low-priority PUSCH, transmit the low-priority PUSCH without transmitting the PUCCH with the positive high-priority SR. The high-priority UCI may include a high-priority hybrid automatic repeat request-acknowledgement (HARQ-ACK).

A base station (gNB) is also described. The base station includes receiving circuitry. The receiving circuitry is configured to, if a physical uplink control channel (PUCCH) for a positive scheduling request (SR) with priority index 1 overlaps with the PUSCH with a priority index 0, and if there is no uplink control information (UCI) or only low-priority UCI is multiplexed on the PUSCH, receive the PUCCH with the positive high-priority SR and cancel reception of a physical uplink shared channel (PUSCH). Or, the receiving circuitry is configured to, if the PUCCH for the positive SR with the priority index 1 overlaps with the PUSCH with the priority index 0, and if there is at least a high-priority UCI multiplexed on the low-priority PUSCH, receive the low-priority PUSCH without receiving the PUCCH with the positive high-priority SR. The high-priority UCI may include a high-priority hybrid automatic repeat request-acknowledgement (HARQ-ACK).

A method by a user equipment (UE) is also described. The method includes determining a channel dropping behavior based on a priority of uplink control information (UCI) multiplexed on a physical uplink shared channel (PUSCH). The method includes transmitting, if a physical uplink control channel (PUCCH) for a positive scheduling request (SR) with priority index 1 overlaps with the PUSCH with a priority index 0, and if there is no UCI or only low-priority UCI is multiplexed on the PUSCH, the PUCCH with the positive high-priority SR and cancelling transmission of the PUSCH. Or, the method includes transmitting, if the PUCCH for the positive SR with the priority index 1 overlaps with the PUSCH with the priority index 0, and if there is at least a high-priority UCI multiplexed on the low-priority PUSCH, the low-priority PUSCH without transmitting the PUCCH with the positive high-priority SR.

A method by a base station (gNB) is also described. The method includes receiving, if a physical uplink control channel (PUCCH) for a positive scheduling request (SR) with priority index 1 overlaps with the PUSCH with a priority index 0, and if there is no UCI or only low-priority UCI is multiplexed on the PUSCH, the PUCCH with the positive high-priority SR and cancelling reception of the PUSCH. Or, the method includes receiving, if the PUCCH for the positive SR with the priority index 1 overlaps with the PUSCH with the priority index 0, and if there is at least a high-priority UCI multiplexed on the low-priority PUSCH, the low-priority PUSCH without receiving the PUCCH with the positive high-priority SR.

Another user equipment (UE) is described. The UE includes transmitting circuitry configured to report a high-priority positive scheduling request (SR) and uplink control information (UCI) multiplexed on a physical uplink shared channel (PUSCH) based on an overlapping condition. A channel dropping procedure with potential simultaneous SR physical uplink control channel (PUCCH) and UCI reporting on the PUSCH may be a feature of the UE. The feature may be supported based on UE capability and is configured by a base station via higher-layer signaling.

The UE may include a processor configured to evaluate the overlapping condition between the UCI multiplexed on the PUSCH and a physical uplink control channel (PUCCH) for a position of the high-priority SR, and to determine whether or not to report UCI together with the high-priority SR. The evaluation may be performed in several steps for all UCIs to reduce or minimize dropping of UCI multiplexed on a low-priority PUSCH.

The evaluation may be performed only for hybrid automatic repeat request-acknowledgement (HARQ-ACKs). The HARQ-ACKs may include at least one of high-priority HARQ-ACK and low-priority HARQ-ACK multiplexed on a low-priority PUSCH. The evaluation may be performed only for high-priority hybrid automatic repeat request-acknowledgement (HARQ-ACK) multiplexed on a low-priority PUSCH.

If there is UCI multiplexed on a low-priority PUSCH, whether a UCI multiplexed on the PUSCH can be reported simultaneously with a high-priority SR physical uplink control channel (PUCCH) may be determined based whether a high-priority SR PUCCH resource overlaps with any of UCI carrying symbols or a corresponding demodulation reference signal (DMRS) for the UCI carrying symbols. If there is overlapping, simultaneous reporting may not be performed for the UCI and channel dropping rules based on multiplexed UCI priority are applied. If there is no overlapping, the UCI may be reported together with the SR.

Another base station (gNB) is also described. The base station includes transmitting circuitry configured to transmit higher-layer signaling to a user equipment (UE). The higher-layer signaling indicates a configuration of a channel dropping procedure with potential simultaneous SR physical uplink control channel (PUCCH) and UCI reporting on the PUSCH.

Another method by a user equipment (UE) is also described. The method includes reporting a high-priority positive scheduling request (SR) and uplink control information (UCI) multiplexed on a physical uplink shared channel (PUSCH) based on an overlapping condition.

Another method by a base station (gNB) is also described. The method includes transmitting higher-layer signaling to a user equipment (UE). The higher-layer signaling indicates a configuration of a channel dropping procedure with potential simultaneous SR physical uplink control channel (PUCCH) and UCI reporting on the PUSCH.

The 3rd Generation Partnership Project, also referred to as “3GPP,” is a collaboration agreement that aims to define globally applicable technical specifications and technical reports for third, fourth, and fifth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and/or other standards (e.g., 3GPP Releases 8, 9, 10, 11, 12, 13, 14, 15, 16, 17, etc.). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In de-scribing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and/or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time/frequency/space resources to allow for enhanced mobile broadband (eMBB) communication and ultra-reliable low-latency communication (URLLC) services, as well as massive machine type communication (MMTC) like services. A new radio (NR) base station may be referred to as a gNB. A gNB may also be more generally referred to as a base station or base station device.

In some approaches, scheduling request (SR) multiplexing on a physical uplink shared channel (PUSCH) is not supported. In case of overlapping between a PUCCH with positive SR and a PUSCH, the SR is dropped if the SR priority is the same as the priority of the PUSCH. The channel with a larger priority index (i.e., high priority) is transmitted and the channel with a smaller priority index (i.e., low priority) is dropped. For overlapping between a low priority (LP) PUSCH and a PUCCH with a positive high priority (HP) SR, the PUCCH with the positive HP SR is transmitted, and the LP PUSCH is dropped. For overlapping between a HP PUSCH and a PUCCH with a positive LP SR, the HP PUSCH is transmitted, and the PUCCH with the positive LP SR is dropped.

If a LP PUSCH overlaps with a PUCCH with a positive HP SR, the LP PUSCH is dropped. However, in some approaches, the HP HARQ-ACK may be multiplexed on a LP PUSCH. Accordingly, dropping the LP PUSCH by the HP SR may drop the more important HP HARQ-ACK multiplexed on the PUSCH.

Some examples of the systems and methods described herein may provide enhancements on channel dropping between SR and PUSCH. For instance, some examples of the systems and methods described herein may provide enhancements of channel dropping behavior when a PUCCH with a positive HP SR overlaps with a LP PUSCH transmission. The dropping behavior may be enhanced based on the UCI multiplexed on the PUSCH.

Some examples of the systems and methods described herein may provide simultaneous SR PUCCH and UCI on a PUSCH with partial dropping. For instance, some examples of the systems and method described herein may provide enhancements on channel dropping behavior when a PUCCH with a positive HP SR overlaps with a LP PUSCH transmission. The channel overlapping condition may be evaluated to determine whether the UCI multiplexed on the PUSCH can be simultaneously reported besides the positive HP PUCCH.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

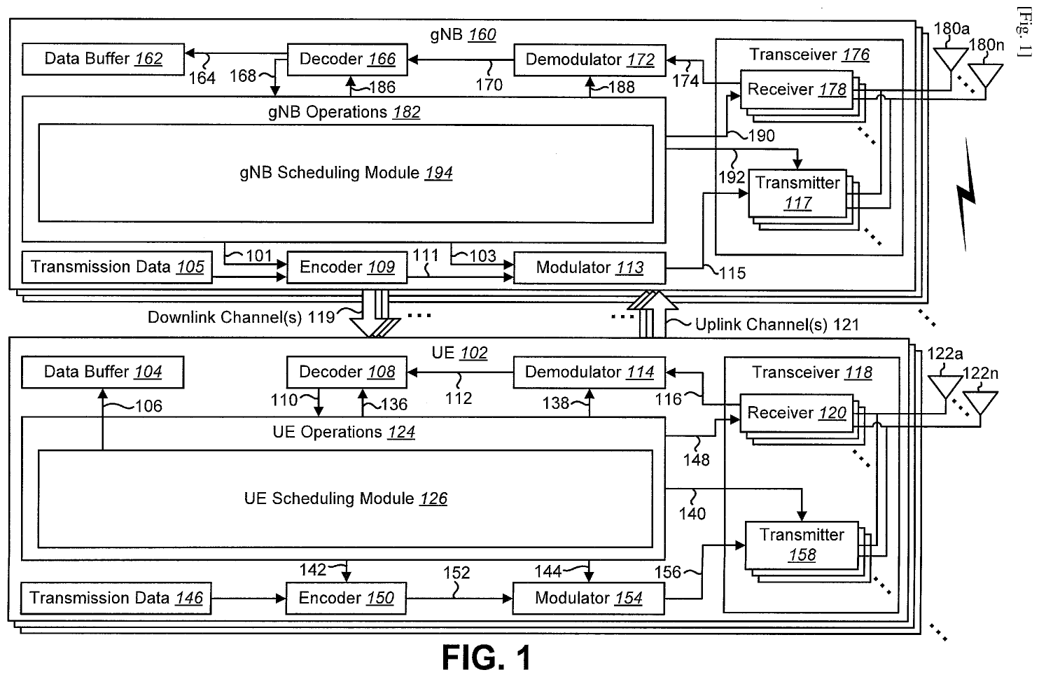

FIG. 1 is a block diagram illustrating one implementation of one or more gNBs 160 and one or more UEs 102 in which systems and methods for channel dropping behaviors may be implemented. The one or more UEs 102 communicate with one or more gNBs 160 using one or more antennas 122a-n. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH (Physical Uplink Control Channel) and a PUSCH (Physical Uplink Shared Channel), PRACH (Physical Random Access Channel), etc. For example, uplink channels 121 (e.g., PUSCH) may be used for transmitting UL data (i.e., Transport Block(s), MAC PDU, and/or UL-SCH (Uplink-Shared Channel)).

In some examples, UL data may include URLLC data. The URLLC data may be UL-SCH data. Here, URLLC-PUSCH (i.e., a different Physical Uplink Shared Channel from PUSCH) may be defined for transmitting the URLLC data. For the sake of simple description, the term “PUSCH” may mean any of (1) only PUSCH (e.g., regular PUSCH, non-URLLC-PUSCH, etc.), (2) PUSCH or URLLC-PUSCH, (3) PUSCH and URLLC-PUSCH, or (4) only URLLC-PUSCH (e.g., not regular PUSCH).

Also, for example, uplink channels 121 may be used for transmitting Hybrid Automatic Repeat Request-ACK (HARQ-ACK), Channel State Information (CSI), and/or Scheduling Request (SR) signals. The HARQ-ACK may include information indicating a positive acknowledgment (ACK) or a negative acknowledgment (NACK) for DL data (i.e., Transport Block(s), Medium Access Control Protocol Data Unit (MAC PDU), and/or DL-SCH (Downlink-Shared Channel)).

The CSI may include information indicating a channel quality of downlink. The SR may be used for requesting UL-SCH (Uplink-Shared Channel) resources for new transmission and/or retransmission. For example, the SR may be used for requesting UL resources for transmitting UL data.

The one or more gNBs 160 may also transmit information or data to the one or more UEs 102 using one or more downlink channels 119, for instance. Examples of downlink channels 119 include a PDCCH, a PDSCH, etc. Other kinds of channels may be used. The PDCCH may be used for transmitting Downlink Control Information (DCI).

Each of the one or more UEs 102 may include one or more transceivers 118, one or more demodulators 114, one or more decoders 108, one or more encoders 150, one or more modulators 154, a data buffer 104, and a UE operations module 124. For example, one or more reception and/or transmission paths may be implemented in the UE 102. For convenience, only a single transceiver 118, decoder 108, demodulator 114, encoder 150, and modulator 154 are illustrated in the UE 102, though multiple parallel elements (e.g., transceivers 118, decoders 108, demodulators 114, encoders 150, and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

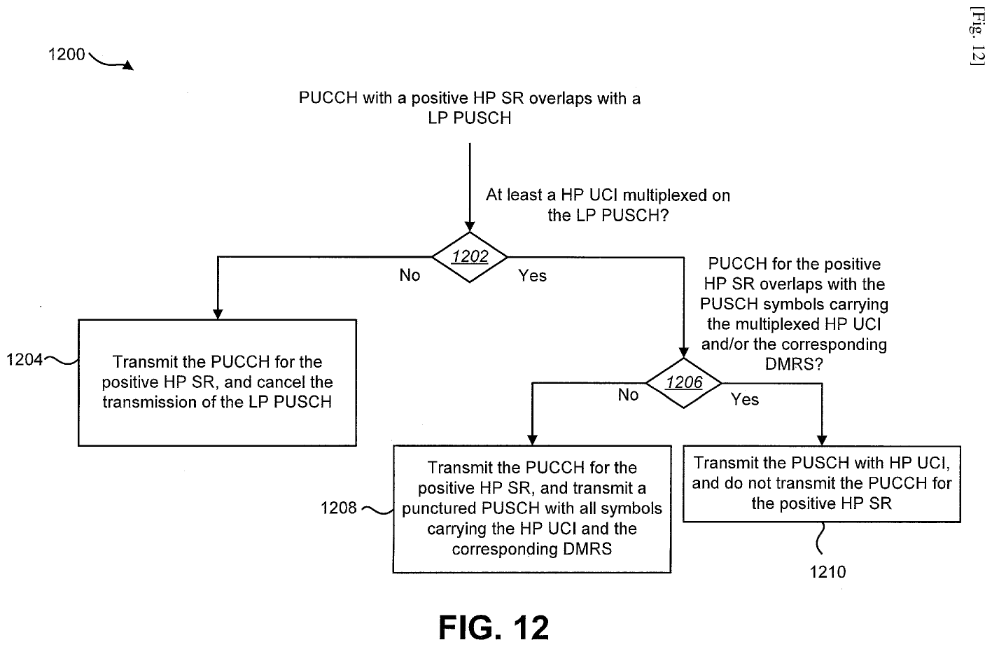

In general, the UE operations module 124 may enable the UE 102 to communicate with the one or more gNBs 160. The UE operations module 124 may include a UE scheduling module 126. In some examples, the UE scheduling module 126 may be utilized to perform joint coding and/or multiplexing of deferred SPS HARQ-ACK as described herein. For instance, the UE 102, the UE operations module 124, and/or the UE scheduling module 126 may perform one or more of the methods (e.g., method 1200 described in relation to FIG. 12, etc.), operations, functions, approaches, and/or examples described herein.

A high priority UCI may be a high priority HARQ-ACK or a high priority SR. A high priority HARQ-ACK corresponds to a high priority PDSCH transmission. A PDSCH may be dynamically scheduled by downlink control information (DCI) or configured by semi-persistent scheduling (SPS). The priority of a scheduled PDSCH transmission may be determined by the priority indication in the scheduling DCI. The priority of a SPS PDSCH transmission may be configured by higher layer signaling. A high priority PUCCH resource may be used to report high priority HARQ-ACK with or without SR. A high priority PDSCH, high priority HARQ-ACK, or high priority PUCCH resource may be configured to support URLLC services. The high priority may be configured with a priority index 1. Thus, a high priority PDSCH/PUSCH may be a PDSCH/PUSCH with priority index 1, a high priority HARQ-ACK may be a HARQ-ACK with priority index 1 corresponding to a PDSCH with priority index 1. A PUCCH resource with priority index 1 may be used to report UCI with priority index 1.

A low priority UCI may be a low priority HARQ-ACK or a low priority SR, or a CSI report, etc. A low priority HARQ-ACK corresponds to a low priority PDSCH transmission. The priority of a scheduled PDSCH transmission may be determined by the priority indication in the scheduling DCI. The priority of a SPS PDSCH transmission may be configured by higher layer signaling. A low priority PUCCH resource may be used to report low priority UCI. A low priority PDSCH, low priority HARQ-ACK, or low priority PUCCH resource may be configured to support eMBB services. The low priority may be configured with a priority index 0. Thus, a low priority PDSCH/PUSCH may be a PDSCH/PUSCH with priority index 0, a low priority HARQ-ACK may be a HARQ-ACK with priority index 0 corresponding to a PDSCH with priority index 0. A PUCCH resource with priority index 0 may be used to report UCI with priority index 0.

For HARQ-ACK priorities, if a UE 102 is provided a pdsch-HARQ-ACK-Codebook-List, the UE 102 can be indicated by the pdsch-HARQ-ACK-Codebook-List to generate one or two HARQ-ACK codebooks. If the UE 102 is indicated to generate two HARQ-ACK codebooks, a first HARQ-ACK codebook may be associated with a PUCCH of priority index 0 and a second HARQ-ACK codebook may be associated with a PUCCH of priority index 1.

For SR priorities, a UE 102 may be configured, by SchedulingRequestResourceConfig, a set of configurations for SR in a PUCCH transmission using either PUCCH format 0 or PUCCH format 1. A UE 102 may be configured, by schedulingRequestIDForBFR, a configuration for a link recovery request (LRR) in a PUCCH transmission using either PUCCH format 0 or PUCCH format 1. The UE 102 can be configured, by schedulingRequestPriority in SchedulingRequestResourceConfig, a priority index 0 or a priority index 1 for the SR.

A PUSCH or a PUCCH, including repetitions if any, may be of priority index 0 or of priority index 1. If a priority index is not provided for a PUSCH or a PUCCH, the priority index may be 0. If in an active DL BWP a UE 102 monitors PDCCH either for detection of DCI format 0_1 and DCI format 1_1 or for detection of DCI format 0_2 and DCI format 1_2, a priority index may be provided by a priority indicator field. If a UE 102 indicates a capability to monitor, in an active DL BWP, PDCCH for detection of DCI format 0_1 and DCI format 1_1 and for detection of DCI format 0_2 and DCI format 1_2, a DCI format 0_1 or a DCI format 0_2 may schedule a PUSCH transmission of any priority and a DCI format 1_1 or a DCI format 1_2 may schedule a PDSCH reception and trigger a PUCCH transmission with corresponding HARQ-ACK information of any priority. If, after resolving overlapping for PUCCH and/or PUSCH transmissions of a same priority index, a UE 102 determines to transmit:
a first PUCCH of larger priority index, a PUSCH or a second PUCCH of smaller priority index, and a transmission of the first PUCCH would overlap in time with a transmission of the PUSCH or the second PUCCH, the UE 102 may not transmit the PUSCH or the second PUCCH;
a PUSCH of larger priority index, a PUCCH of smaller priority index, and a transmission of the PUSCH would overlap in time with a transmission of the PUCCH, the UE 102 may not transmit the PUCCH; or
a first PUSCH of larger priority index on a serving cell, a second PUSCH of smaller priority index on the serving cell, and a transmission of the first PUSCH would overlap in time with a transmission of the second PUSCH, the UE 102 may not transmit the second PUSCH, where at least one of the two PUSCH is not scheduled by a DCI format.
   In NR Rel-16, a UE 102 may only multiplex UCIs with a same priority index in a PUCCH or a PUSCH. A PUCCH or a PUSCH may be assumed to have a same priority index as a priority index of UCIs a UE 102 multiplexes in the PUCCH or the PUSCH. For intra-UE collision between uplink channels with different priorities, the uplink channel with high priority may be transmitted, and the low priority channel may be dropped.

If a UE 102 is provided two PUCCH-Config:
if the UE 102 is provided subslotLengthForPUCCH-r16 in the first PUCCH-Config, the PUCCH resource for any SR configuration with priority index 0 or any CSI report configuration in any PUCCH-Config may be within the subslotLengthForPUCCH-r16 symbols in the first PUCCH-Config; or
if the UE 102 is provided subslotLengthForPUCCH-r16 in the second PUCCH-Config, the PUCCH resource for any SR configuration with priority index 1 in any PUCCH-Config may be within the subslotLengthForPUCCH-r16 symbols in the second PUCCH-Config.
   In some examples, if a UE 102 is not provided subslotLength-ForPUCCH, a slot for an associated PUCCH transmission may include all symbols in a slot, 14 symbols with normal cyclic prefix, or 12 symbols with extended cyclic prefix. And, if a UE 102 is provided subslotLength-ForPUCCH, a slot for an associated PUCCH transmission may include a number of symbols indicated by subslotLength-ForPUCCH.

In some approaches, UCI multiplexing on PUSCH may be performed in accordance with the following. If a PUCCH carrying a UCI overlaps with a PUSCH, the UCI may be multiplexed on PUSCH if simultaneous PUCCH and PUSCH is not configured or supported. In some examples, only HARQ-ACK and CSI may be multiplexed on PUSCH, and SR may not be multiplexed on PUSCH in some approaches.

When UCI is multiplexed on a PUSCH, the overlapping condition of the PUCCH for a UCI type may be evaluated separately with the PUSCH, and the UCI multiplexing of different UCI types may be multiplexed on PUSCH based on the UCI types, for example, the HARQ-ACK may be multiplexed first based on the number of HARQ-ACK bits, followed by CSI which is rate matched after the HARQ-ACK multiplexing.

Offset values may be defined for a UE 102 to determine a number of resources for multiplexing HARQ-ACK information and for multiplexing CSI reports in a PUSCH. Offset values may also be defined for multiplexing configured grant UCI (CG-UCI) in a configured grant PUSCH (CG-PUSCH). The offset values may be signaled to a UE 102 either by a DCI format scheduling the PUSCH transmission or by higher layers.

In Rel-16, for a PUSCH with a given priority index, only the UCI with the same priority that is configured on a PUCCH with the same priority, may be multiplexed on the PUSCH. If the UCI and PUSCH have different priorities, a channel dropping rule is defined so that the high priority channel is transmitted, and the low priority channel is dropped in case of channel overlapping. Dropping timelines are defined for different types of UL channels and UCI types.

In NR Rel-17, UCI of different priorities may be multiplexed on a single PUCCH or PUSCH. Furthermore, a UCI with a given priority may be multiplexed on a PUSCH with different priorities. Thus, using HARQ-ACK as an example, the followings UCI multiplexing scenarios may be supported:
HP HARQ-ACK on HP PUSCH
LP HARQ-ACK on LP PUSCH
HP HARQ-ACK on LP PUSCH
LP HARQ-ACK on HP PUSCH
   Different offset values or sets of offset values may be configured for different combinations between the HARQ-ACK priority and PUSCH priority. Furthermore, HARQ-ACK of different priorities may be reported on a single PUSCH, including:
HP HARQ-ACK and LP HARQ-ACK on LP PUSCH
HP HARQ-ACK and LP HARQ-ACK on HP PUSCH
   CSI may be treated as low priority in Rel-16. If CSI is present on a LP PUSCH, the HP UCI may also be multiplexed on a LP PUSCH, including
HP HARQ-ACK and CSI on LP PUSCH
HP HARQ-ACK, LP HARQ-ACK and CSI on LP PUSCH
   The CSI may be a periodic CSI, a semi-persistent CSI, or an aperiodic CSI. When multiplexed together with HP UCI on PUSCH, the low priority CSI may be limited to CSI part 1 only.

In Rel-17, CSI enhancements may be considered, and some new CSI reports may be supported for URLLC or the high priority service. The new CSI reports may be treated as high priority, or indicated as high priority (i.e., priority index 1). The HP CSI may be reported together with HP HARQ-ACK on a PUCCH or PUSCH.

Some approaches for collision handling between PUCCH with positive SR and PUSCH are described as follows. The Scheduling Request (SR) is a special physical layer message for UE 102) used for requesting UL-SCH resources for a new transmission. The MAC entity may be configured with zero, one, or more SR configurations. An SR configuration may include a set of PUCCH resources for SR across different BWPs and cells. For a logical channel or for SCell beam failure recovery and for consistent listen before talk (LBT) failure recovery, at most one PUCCH resource for SR may be configured per bandwidth part (BWP).

Each SR configuration may correspond to one or more logical channels and/or to SCell beam failure recovery and/or to consistent LBT failure recovery. Each logical channel, SCell beam failure recovery, and/or consistent LBT failure recovery may be mapped to zero or one SR configuration, which is configured by RRC. The SR configuration of the logical channel that triggered a buffer status report (BSR) or the SCell beam failure recovery or the consistent LBT failure recovery (if such a configuration exists) is considered as corresponding SR configuration for the triggered SR. Any SR configuration may be used for an SR triggered by Pre-emptive BSR.

A UE 102 may be configured, by SchedulingRequestResourceConfig, a set of configurations for SR in a PUCCH transmission using either PUCCH format 0 or PUCCH format 1. A UE 102 may be configured, by schedulingRequestID-BFR-SCell-r16, a configuration for LRR in a PUCCH transmission using either PUCCH format 0 or PUCCH format 1. The UE 102 may be provided, by phy-PriorityIndex-r16 in SchedulingRequestResourceConfig, a priority index 0 or a priority index 1 for the SR. If the UE 102 is not provided a priority index for SR, the priority index may be 0.

The UE 102 may transmit a PUCCH in the PUCCH resource for the corresponding SR configuration only when the UE 102 transmits a positive SR. For a positive SR transmission using PUCCH format 0, the UE 102 may transmit the PUCCH by obtaining initial cycle shift m₀ as described for HARQ-ACK information and by setting an additional cycle shift m_{cs}=0. For a positive SR transmission using PUCCH format 1, the UE 102 may transmit the PUCCH by setting the information bit b(0)=0. If the PUCCH for a positive SR does not overlap with another PUCCH or PUSCH, the PUCCH for the positive SR may be transmitted at the configured PUCCH resource.

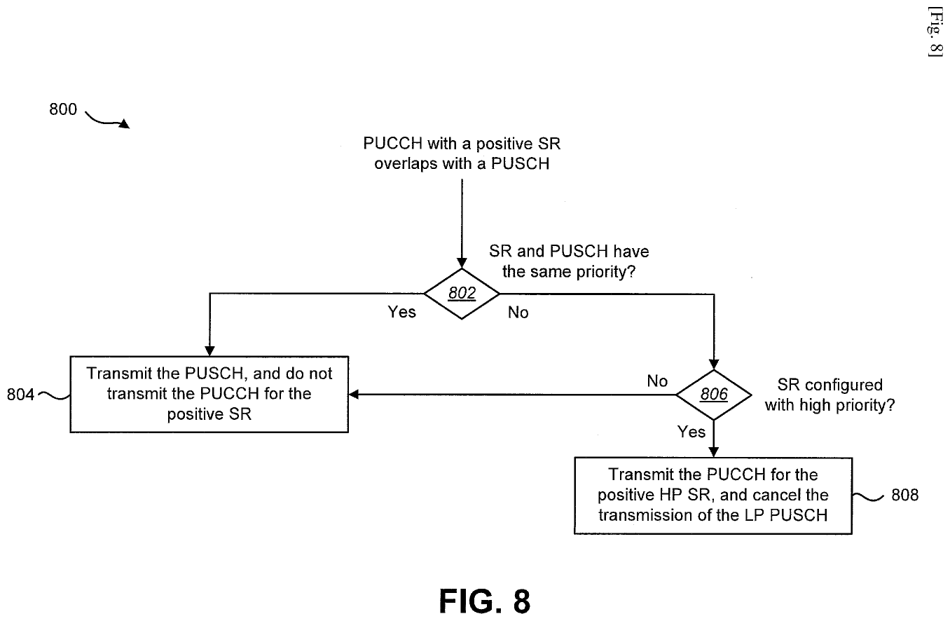

In NR, up to 8 SR may be configured. In some NR approaches, the SR cannot be reported on PUSCH as illustrated in FIG. 8. Some problems may occur with dropping for a SR collision with PUSCH. Since SR cannot be multiplexed on a PUSCH in those approaches, the channel dropping approaches may function for some scenarios (e.g., the SR is dropped if the PUCCH of a positive SR overlaps with a PUSCH with the same priority, and the LP SR is dropped if the PUCCH of a positive SR with priority index 0 overlaps with a PUSCH with a priority index 1). In these approaches, however, for overlapping between a PUCCH with a positive SR with high priority and a PUSCH with low priority, the PUCCH with high priority SR has a high priority and will be transmitted, and the PUSCH with low priority is dropped. For example, if a UE would transmit the following channels that would overlap in time between a first PUCCH of larger priority index with SR and a PUSCH of smaller priority index, the UE is expected to cancel the PUSCH transmissions of smaller priority index before the first symbol overlapping with the PUCCH transmission of the larger priority index. This behavior ensures that the high priority SR is reported with a tradeoff of a dropped LP PUSCH transmission. Since an SR may only carry 1 bit information, the overhead of dropping a PUSCH is significant because the base station (e.g., gNB) may need to reschedule for the UE to retransmit the PUSCH. Furthermore, since UCI can be multiplexed on a LP PUSCH, dropping the LP PUSCH by a HP SR PUCCH may also drop UCI multiplexed on the LP PUSCH. Especially, if a high priority HARQ-ACK is multiplexed on a LP PUSCH, dropping the LP PUSCH by a HP SR PUCCH may drop the more important HP HARQ-ACK information on the LP PUSCH.

Some of the systems and methods described herein may provide enhancements relative to channel dropping between SR and PUSCH. For example, some of the techniques described herein may utilize UCI multiplexing enhancements between UCIs with different priorities and/or UCI multiplexing on a channel with different priority. In some examples, with support of multiplexing of UCI with different priorities on PUSCH, channel dropping behavior may be determined based on the priority of UCI multiplexed on PUSCH. In some examples, UE 102 channel dropping behavior may be enhanced to differentiate the PUSCH with or without multiplexed UCI and the UCI priorities. For instance, the UE 102 channel dropping behavior may be enhanced for the case where SR PUCCH of a positive SR with priority index 1 overlaps with a PUSCH with a priority index 0. In some examples of the techniques described herein, a UE (e.g., UE 102) may transmit or may not transmit information (e.g., PUSCH, PUCCH, UCI, SR, and/or HARQ-ACK, etc.). In some examples, a base station (e.g., eNB 160) correspondingly may receive or may not receive the information (e.g., PUSCH, PUCCH, UCI, SR, and/or HARQ-ACK, etc.) described in relation to a UE herein.

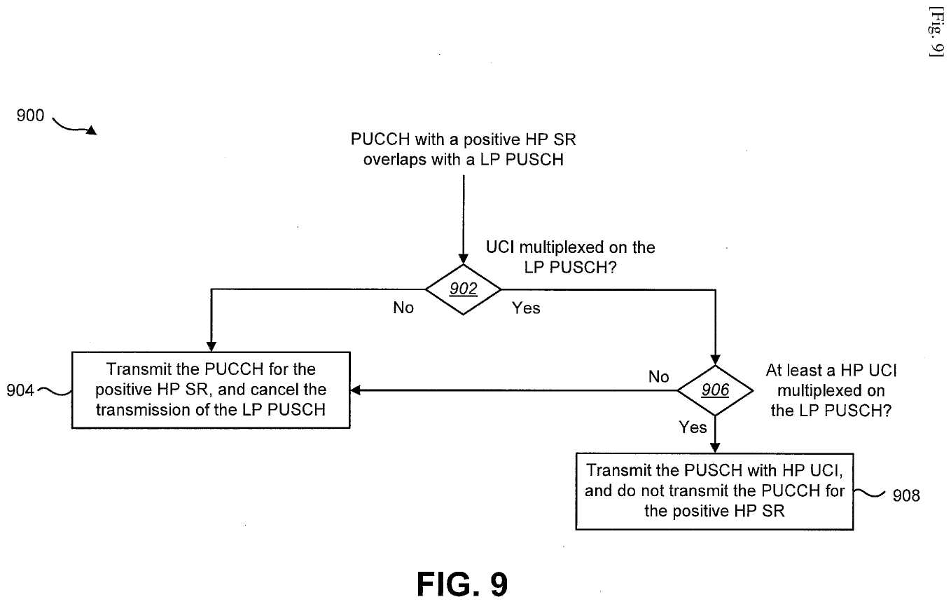

In some approaches for channel dropping enhancement when a PUCCH with a positive HP SR overlaps with a LP PUSCH, if HP UCI is multiplexed on the LP PUSCH, the HP SR may be dropped. Otherwise, if no HP UCI is multiplexing the LP PUSCH, the HP SR may be reported. For example, in case of a PUCCH where a positive HP SR overlaps with a LP PUSCH, whether the LP PUSCH is cancelled by a HP SR or not may be further determined by the priority of the UCIs carried on the LP PUSCH. The method 900 described in relation to FIG. 9 illustrates an example of techniques that may be utilized in accordance with some of the systems and methods described herein. For example, the UE 102 (e.g., UE operations module 124 and/or UE scheduling model 126) may perform one or more of the operations described in relation to FIG. 9. In some examples, the UE 102 may perform one or more of the operations described in relation to FIG. 8.

Some examples of the techniques described herein may provide simultaneous SR PUCCH and UCI on PUSCH with partial dropping. In some examples of the channel dropping described above, only one channel may be transmitted, and the other channel may be dropped. The LP PUSCH may have HP UCI and/or LP UCI multiplexed on it. In case of UCI multiplexed on PUSCH, either the positive HP SR or the UCI on PUSCH may be reported, but not both, in some examples. If there is no high priority UCI (e.g., HP HARQ-ACK) multiplexed on a LP PUSCH, the previous dropping behavior may be utilized so that only the PUCCH for the positive HP SR is transmitted. Thus, the LP PUSCH may be dropped, and the HP SR PUCCH may be transmitted. In this case, the LP PUSCH may be a PUSCH with or without data, and with or without other UCIs such as a LP HARQ-ACK or a CSI, etc., for example. If the LP PUSCH is dropped, the UCI multiplexed on the LP PUSCH (e.g., LP HARQ-ACK and/or CSI) may also be dropped and may not be received by a gNB.

Additional or alternative enhancement may be utilized to allow reporting of both the HP positive SR and the UCI multiplexed on the PUSCH if some conditions are satisfied. This may be particularly beneficial if the UCI is a HARQ-ACK.

In some examples, advanced dropping approaches with potentially simultaneous SR PUCCH and UCI reporting on PUSCH may be provided as a separate UE 102 feature. In some examples, the feature may be configured by the gNB 160 via higher layer signaling (e.g., RRC signaling). In some examples, the feature may be configured with a new RRC parameters (e.g., simultanousSRandPUSCH, etc.). In some examples, the feature may be supported by UE 102 capabilities. In some examples, the feature may be configured only if a UE 102 is capable of supporting such a feature.

In some approaches, if there is no UCI multiplexed on the LP PUSCH, the PUCCH for the positive HP SR may be transmitted and the PUSCH transmission may be cancelled. If there is UCI multiplexed on the LP PUSCH, whether a UCI multiplexed on the PUSCH can be reported simultaneously with the HP SR PUCCH may be determined based whether a HP SR PUCCH resource overlaps with any UCI carrying symbols and/or the corresponding DMRS for the UCI carrying symbols. If there is overlap, simultaneous reporting may not be performed, and channel dropping rules based on the multiplexed UCI priority may be applied.

Examples of detailed scenarios for advanced dropping techniques with overlapping condition evaluations are provided below for different types of UCI combinations.

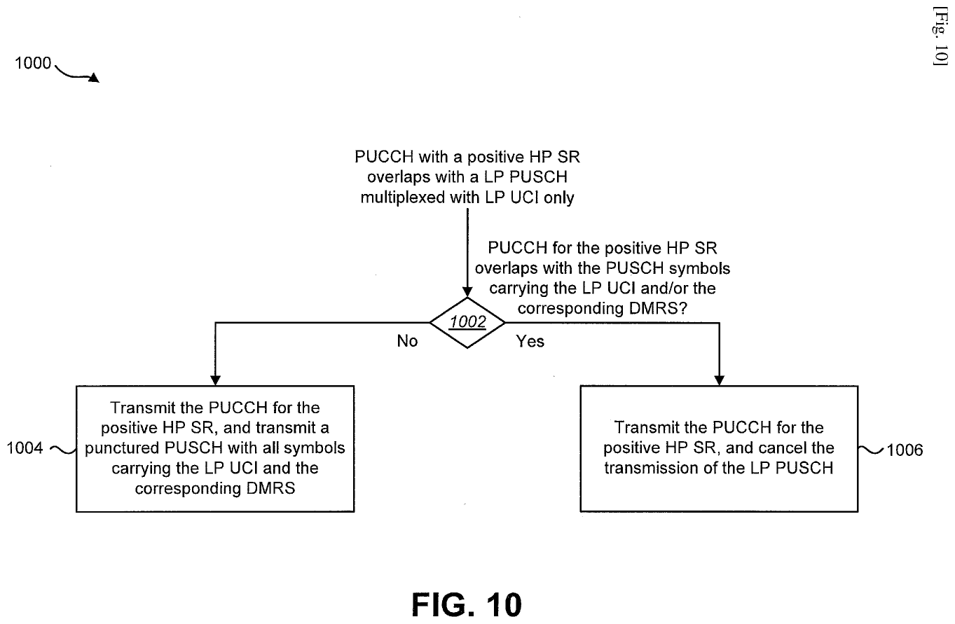

In Case 1, a PUCCH for a positive HP SR overlaps with a LP PUSCH multiplexed with LP UCI only. If there is no high priority UCI multiplexed on a LP PUSCH, but LP UCI is multiplexed on the LP PUSCH, techniques may be implemented for the LP UCI, where the UE 102 (e.g., UE operations module 124, UE scheduling module 126, etc.) may evaluate some timing conditions to determine the dropping behavior, as shown in FIG. 10.

In a scenario where both LP HARQ-ACK and CSI are multiplexed on the LP PUSCH, one or more approaches may be utilized in accordance with the techniques described herein. In one approach, the overlapping conditions may be evaluated based on the LP HARQ-ACK only to determine the dropping behavior as described herein. The CSI may not be considered.

Alternatively, in some approaches, the overlapping conditions may be evaluated based on the LP HARQ-ACK and CSI part 1 to determine the dropping behavior as described herein. The CSI part 2, if present, may not be considered in some examples.

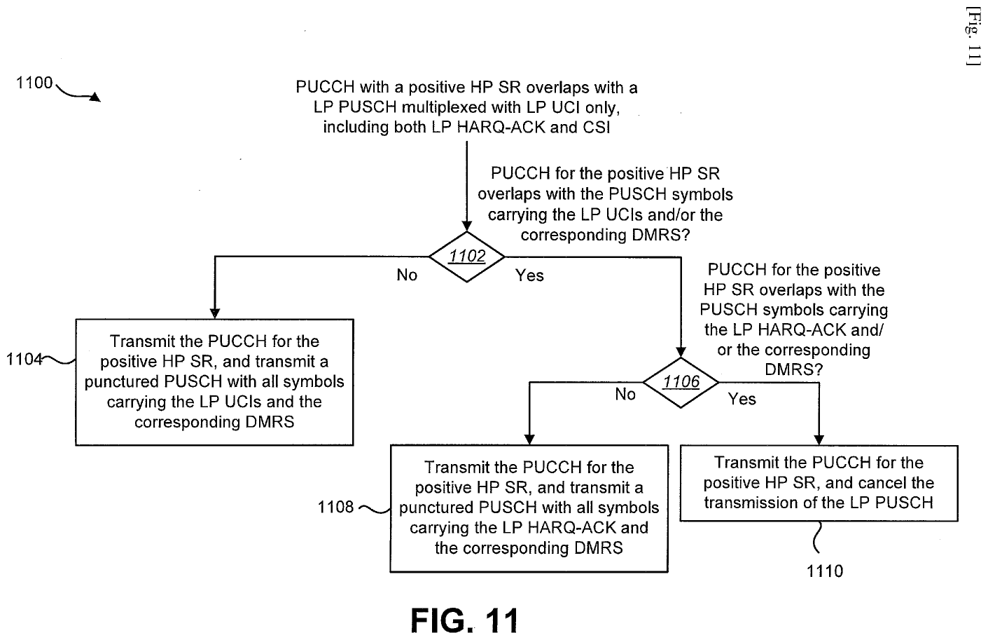

Additionally or alternatively, in some approaches, several operations may be performed as shown in FIG. 11. For instance, the UE 102 may perform one or more of the operations described in relation to FIG. 11. In these approaches, the overlapping conditions may be evaluated based on symbols carrying both HARQ-ACK and CSI first.

In Case 2, a PUCCH for a positive HP SR overlaps with a LP PUSCH multiplexed with HP UCI. For example, a PUCCH with a positive HP SR may overlap with a LP PUSCH, and if there is at least a high priority UCI (e.g., a HP HARQ-ACK) multiplexed on the LP PUSCH, the UE 102 may evaluate some timing conditions to determine the dropping behavior. An example of overlapping condition evaluation between HP UCI and HP SR is given in relation to FIG. 12. In some examples, the UE 102 may perform one or more of the operations described in relation to FIG. 12.

In Case 3, a PUCCH for a positive HP SR overlaps with a LP PUSCH multiplexed with both HP and LP UCI. UCI with different priorities may be multiplexed on a single PUSCH. Accordingly, the following variations are possible:
HP HARQ-ACK and LP HARQ-ACK multiplexed on a LP PUSCH
HP HARQ-ACK, LP HARQ-ACK, and CSI multiplexed on a LP PUSCH

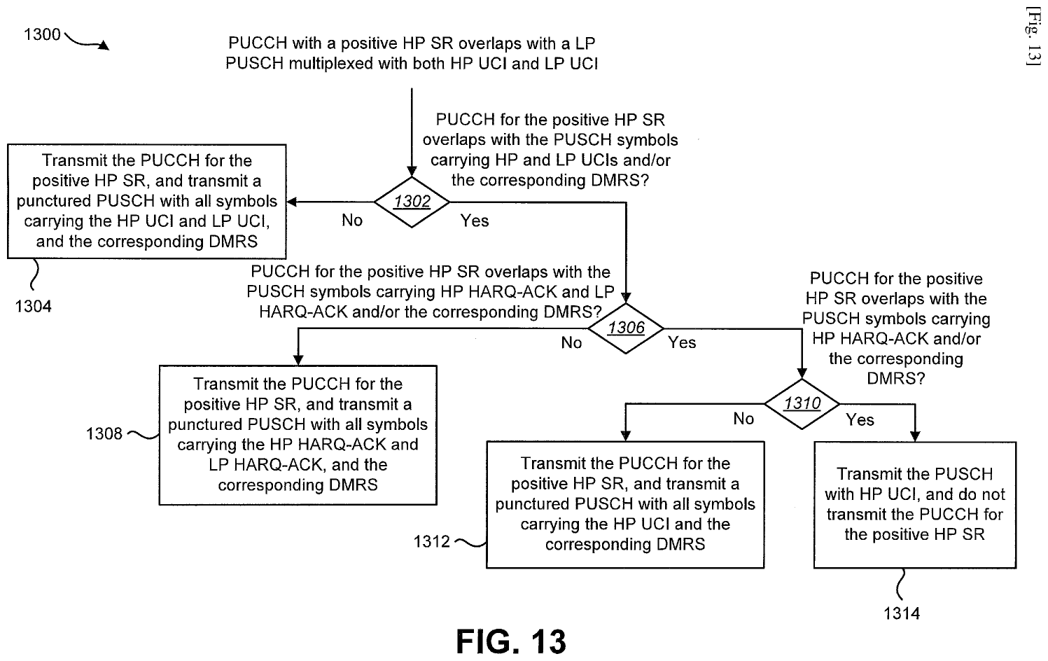

In an example where a PUCCH with a positive HP SR overlaps with a LP PUSCH multiplexed with UCIs with different priorities, the method given in association with Case 2 may be used by evaluating overlapping conditions with only the HP UCI (e.g., HP HARQ-ACK). Additionally or alternatively, the overlapping conditions may be evaluated in several steps based on symbols carrying both HP UCI and LP UCI, as described in relation to FIG. 13, which may assume that all UCIs are present, including HP HARQ-ACK, LP HARQ-ACK, and CSI. In some examples, the UE 102 may perform one or more of the operations described in relation to FIG. 13.

Some examples of the procedures described herein may evaluate all UCIs first and then may remove the UCIs in steps from low priority to high priority according to whether UCI can be reported, and if so, what UCIs can be reported on PUSCH. If there is UCI multiplexed on the LP PUSCH, whether a UCI multiplexed on the PUSCH can be reported simultaneously with the HP SR PUCCH may be determined based whether the HP SR PUCCH resource overlaps with any UCI carrying symbols and/or the corresponding DMRS for the UCI carrying symbols. If there is overlap, simultaneous reporting may not be performed for the given UCI and/or channel dropping rules based on the multiplexed UCI priority may be applied.

In some examples, taking all potential UCIs on the LP PUSCH into account, to minimize the dropping of multiplexed UCI on PUSCH, the overlapping evaluation may be performed in several steps:
1. If there is no UCI multiplexed on the LP PUSCH, the UE 102 may transmit the PUCCH for the positive HP SR and may cancel the transmission of the LP PUSCH.
2. If there is at least one UCI multiplexed on the LP PUSCH, the UE 102 may evaluate whether all UCIs multiplexed on the PUSCH may be reported simultaneously with the HP SR PUCCH.
3. If the HP SR PUCCH resource does not overlap with any UCI carrying symbols and/or the corresponding DMRS for the UCI carrying symbols, all UCIs multiplexed on the PUSCH may be reported simultaneously with the HP SR PUCCH. Thus, the UE 102 may transmit the PUCCH for the HP positive SR and may transmit a punctured PUSCH with at least all symbols carrying the UCIs and the corresponding DMRS in the PUSCH.
4. If the HP SR PUCCH resource overlaps with any UCI carrying symbols and/or the corresponding DMRS for the UCI carrying symbols, the UE 102 may determine if HARQ-ACK, including HP HARQ-ACK and/or LP HARQ-ACK, is multiplexed on the LP PUSCH.
5. If the UE 102 determines that HARQ-ACK is not multiplexed on the LP PUSCH, and only CSI is multiplexed on the LP PUSCH, the UE 102 may transmit the PUCCH for the positive HP SR and may cancel the transmission of the LP PUSCH.
6. If the UE 102 determines that HARQ-ACK is multiplexed on the LP PUSCH, the UE 102 may further evaluate whether all HARQ-ACKs (including HP HARQ-ACK if present and/or LP HARQ-ACK if present) multiplexed on the PUSCH may be reported simultaneously with the HP SR PUCCH.
7. If the HP SR PUCCH resource does not overlap with any HARQ-ACK carrying symbols and/or the corresponding DMRS for the HARQ-ACK carrying symbols, all HARQ-ACKs multiplexed on the PUSCH may be reported simultaneously with the HP SR PUCCH. Thus, the UE 102 may transmit the PUCCH for the HP positive SR and may transmit a punctured PUSCH with at least all symbols carrying the HARQ-ACKs and the corresponding DMRS in the PUSCH.
8. If the HP SR PUCCH resource overlaps with any HARQ-ACK carrying symbols and/or the corresponding DMRS for the HARQ-ACK carrying symbols, the UE 102 may further determine if HP HARQ-ACK is multiplexed on the LP PUSCH.
9. If the UE 102 determines that HP HARQ-ACK is not multiplexed on the LP PUSCH, and only LP HARQ-ACK is multiplexed on the LP PUSCH, the UE 102 may transmit the PUCCH for the positive HP SR and may cancel the transmission of the LP PUSCH.
10. If the UE 102 determines that HP HARQ-ACK is multiplexed on the LP PUSCH, the UE 102 may further evaluate whether HP HARQ-ACK multiplexed on the PUSCH may be reported simultaneously with the HP SR PUCCH.
11. If the HP SR PUCCH resource does not overlap with any HP HARQ-ACK carrying symbols and/or the corresponding DMRS for the HP HARQ-ACK carrying symbols, the HP HARQ-ACK multiplexed on the PUSCH may be reported simultaneously with the HP SR PUCCH. Thus, the UE 102 may transmit the PUCCH for the HP positive SR and may transmit a punctured PUSCH with at least all symbols carrying the HP HARQ-ACKs and the corresponding DMRS in the PUSCH.
12. If the HP SR PUCCH resource overlaps with any HP HARQ-ACK carrying symbols and/or the corresponding DMRS for the HP HARQ-ACK carrying symbols, the HP HARQ-ACK multiplexed on the PUSCH may not be reported simultaneously with the HP SR PUCCH. The UE 102 may transmit the PUSCH with all multiplexed UCIs and may not transmit the PUCCH for the positive HP SR.
   In some examples, the foregoing procedure can be simplified by considering only HARQ-ACK. For example, steps 2-4 may be removed and the evaluation may be performed from step 5 directly in case of UCI that is multiplexed on the LP PUSCH. In some examples, the foregoing procedure may be further simplified by considered only HP UCI. For example, the procedure may fall back to the flowchart in FIG. 12 for Case 2 above.

In some examples, the foregoing procedure evaluates all UCIs first. If all UCIs will not fit, then it may be checked whether the maximum UCI can be reported simultaneously with the SR PUCCH. Alternatively, a “water filling” approach may be used considering all potential UCIs on the LP PUSCH. Accordingly, the overlapping evaluation may be performed in steps from the UCIs with highest priority first. The UE 102 may try to keep the symbols for different types of UCIs as much as possible if simultaneous reporting with the positive HP SR PUCCH is possible.

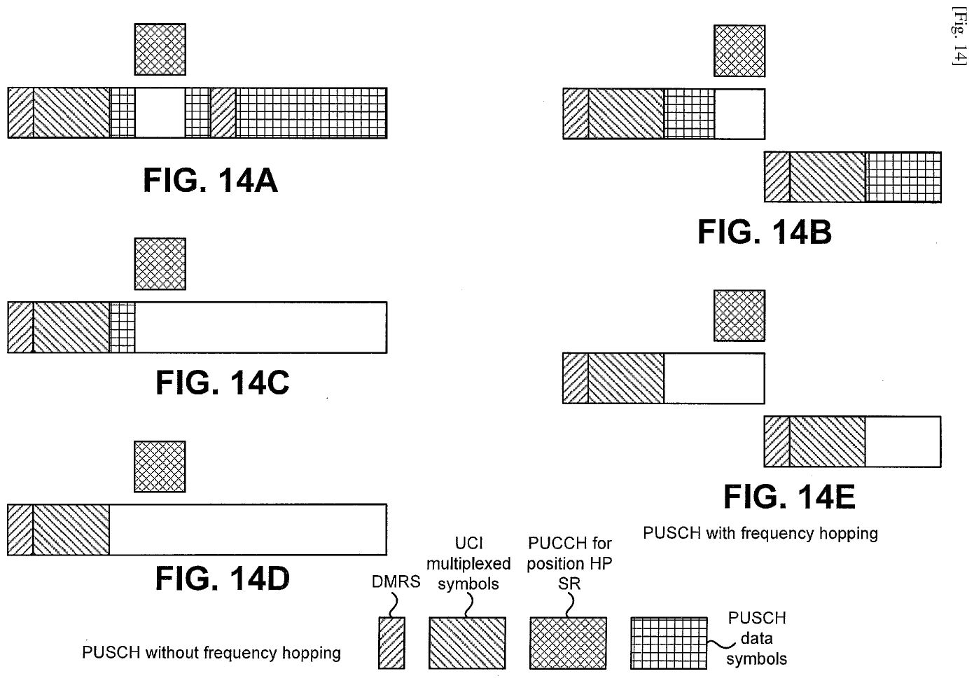

In some examples, LP PUSCH puncturing behaviors may be utilized. One or more of several different approaches may be utilized. For example, the UE 102 and/or the gNB 160 may utilize puncturing as described in relation to one or more of FIGS. 14A, 14B, 14C, 14D, and/or 14E.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162, and a gNB operations module 182. For example, one or more reception and/or transmission paths may be implemented in a gNB 160. For convenience, only a single transceiver 176, decoder 166, demodulator 172, encoder 109, and modulator 113 are illustrated in the gNB 160, though multiple parallel elements (e.g., transceivers 176, decoders 166, demodulators 172, encoders 109, and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include a gNB scheduling module 194. The gNB scheduling module 194 may perform operations as described herein. In some examples, the gNB scheduling module 194 may be utilized to configure dropping and/or puncturing procedures and/or to receive communications from a UE in accordance with the dropping and/or puncturing procedures described herein. For instance, the gNB 160, the gNB operations module 182, and/or the gNB scheduling module 194 may receive transmissions from the UE in accordance with one or more of the methods (e.g., methods 800, 900, 1000, 1100, 1200, 1300 described in relation to FIG. 13, etc.), operations, functions, approaches, and/or examples described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

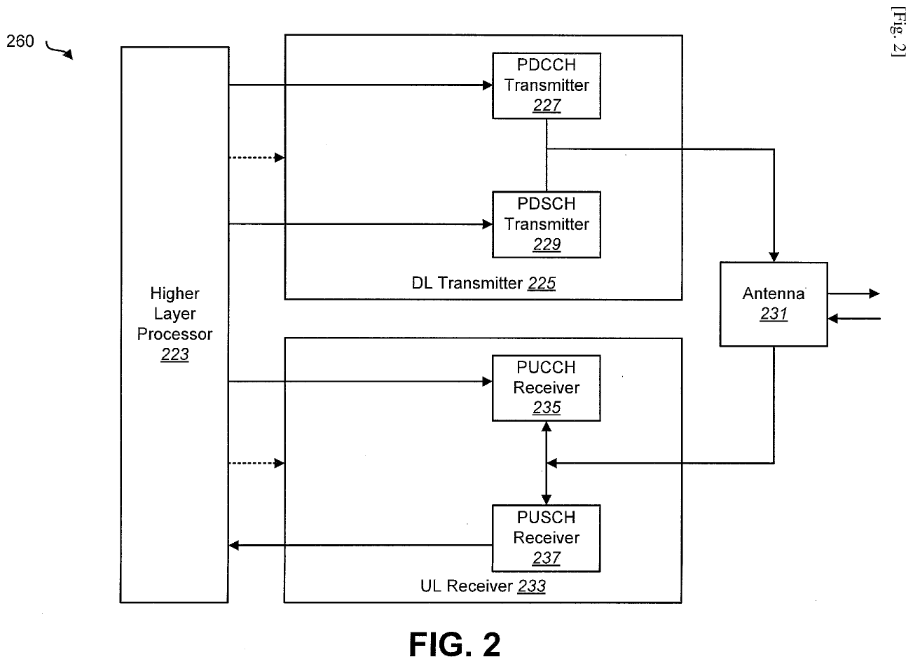

FIG. 2 is a block diagram illustrating one implementation of a gNB 260. The gNB 260 may be implemented in accordance with the gNB 160 described in connection with FIG. 1 in some examples, and/or may perform one or more of the functions described herein. The gNB 260 may include a higher layer processor 223, a DL transmitter 225, a UL receiver 233, and one or more antenna 231. The DL transmitter 225 may include a PDCCH transmitter 227 and a PDSCH transmitter 229. The UL receiver 233 may include a PUCCH receiver 235 and a PUSCH receiver 237.

The higher layer processor 223 may manage physical layer's behaviors (the DL transmitter's and the UL receiver's behaviors) and provide higher layer parameters to the physical layer. The higher layer processor 223 may obtain transport blocks from the physical layer. The higher layer processor 223 may send/acquire higher layer messages such as an RRC message and MAC message to/from a UE's higher layer. The higher layer processor 223 may provide the PDSCH transmitter transport blocks and provide the PDCCH transmitter transmission parameters related to the transport blocks.

The DL transmitter 225 may multiplex downlink physical channels and downlink physical signals (including reservation signal) and transmit them via transmission antennas 231. The UL receiver 233 may receive multiplexed uplink physical channels and uplink physical signals via receiving antennas 231 and de-multiplex them. The PUCCH receiver 235 may provide the higher layer processor 223 UCI. The PUSCH receiver 237 may provide the higher layer processor 223 received transport blocks.

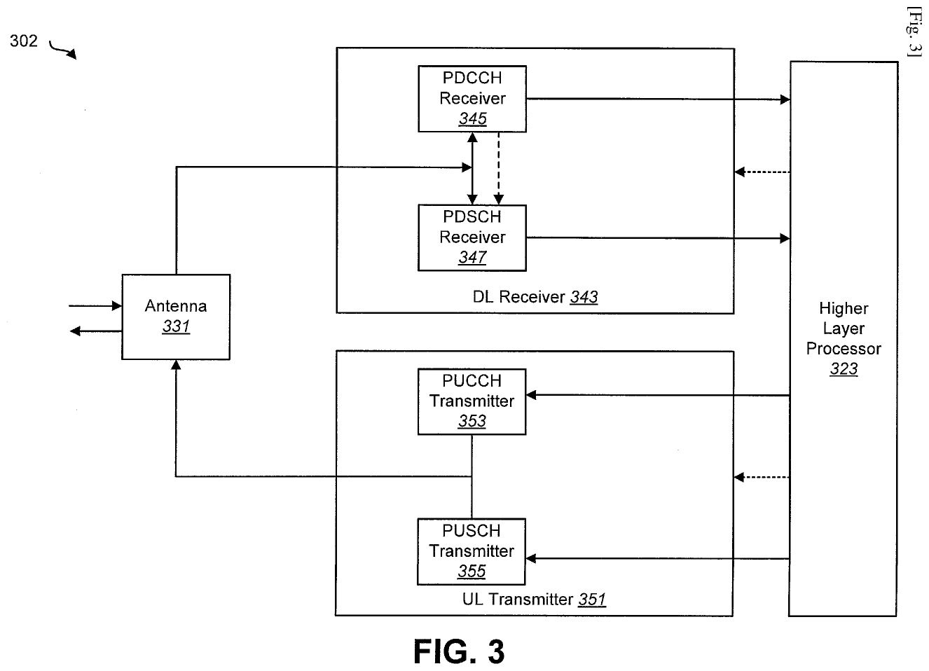

FIG. 3 is a block diagram illustrating one implementation of a UE 302. The UE 302 may be implemented in accordance with the UE 102 described in connection with FIG. 1 in some examples, and/or may perform one or more of the functions described herein. The UE 302 may include a higher layer processor 323, a UL transmitter 351, a DL receiver 343, and one or more antenna 331. The UL transmitter 351 may include a PUCCH transmitter 353 and a PUSCH transmitter 355. The DL receiver 343 may include a PDCCH receiver 345 and a PDSCH receiver 347.

The higher layer processor 323 may manage physical layer's behaviors (the UL transmitter's and the DL receiver's behaviors) and provide higher layer parameters to the physical layer. The higher layer processor 323 may obtain transport blocks from the physical layer. The higher layer processor 323 may send/acquire higher layer messages such as an RRC message and MAC message to/from a UE's higher layer. The higher layer processor 323 may provide the PUSCH transmitter transport blocks and provide the PUCCH transmitter 353 UCI.

The DL receiver 343 may receive multiplexed downlink physical channels and downlink physical signals via receiving antennas 331 and de-multiplex them. The PDCCH receiver 345 may provide the higher layer processor 323 DCI. The PDSCH receiver 347 may provide the higher layer processor 323 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

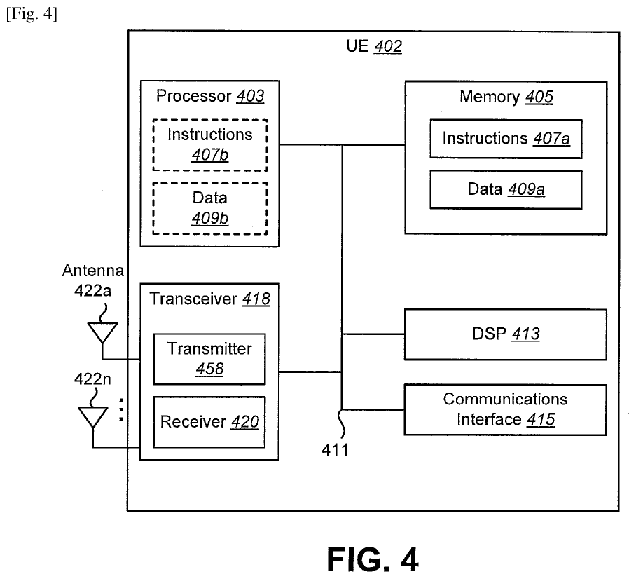

FIG. 4 illustrates various components that may be utilized in a UE 402. The UE 402 described in connection with FIG. 4 may be implemented in accordance with the UE 102 described in connection with FIG. 1. In some examples, the UE 402 may perform one or more of the methods, functions, operations, and/or examples, etc., described herein. The UE 402 includes a processor 403 that controls operation of the UE 402. The processor 403 may also be referred to as a central processing unit (CPU). Memory 405, which may include read-only memory (ROM), random access memory (RAM), a combination of the two or any type of device that may store information, provides instructions 407a and data 409a to the processor 403. A portion of the memory 405 may also include non-volatile random-access memory (NVRAM). Instructions 407b and data 409b may also reside in the processor 403. Instructions 407b and/or data 409b loaded into the processor 403 may also include instructions 407a and/or data 409a from memory 405 that were loaded for execution or processing by the processor 403. The instructions 407b may be executed by the processor 403 to implement the methods described above.

The UE 402 may also include a housing that contains one or more transmitters 458 and one or more receivers 420 to allow transmission and reception of data. The transmitter(s) 458 and receiver(s) 420 may be combined into one or more transceivers 418. One or more antennas 422a-n are attached to the housing and electrically coupled to the transceiver 418.

The various components of the UE 402 are coupled together by a bus system 411, which may include a power bus, a control signal bus, and a status signal bus, in addition to a data bus. However, for the sake of clarity, the various buses are illustrated in FIG. 4 as the bus system 411. The UE 402 may also include a digital signal processor (DSP) 413 for use in processing signals. The UE 402 may also include a communications interface 415 that provides user access to the functions of the UE 402. The UE 402 illustrated in FIG. 4 is a functional block diagram rather than a listing of specific components.

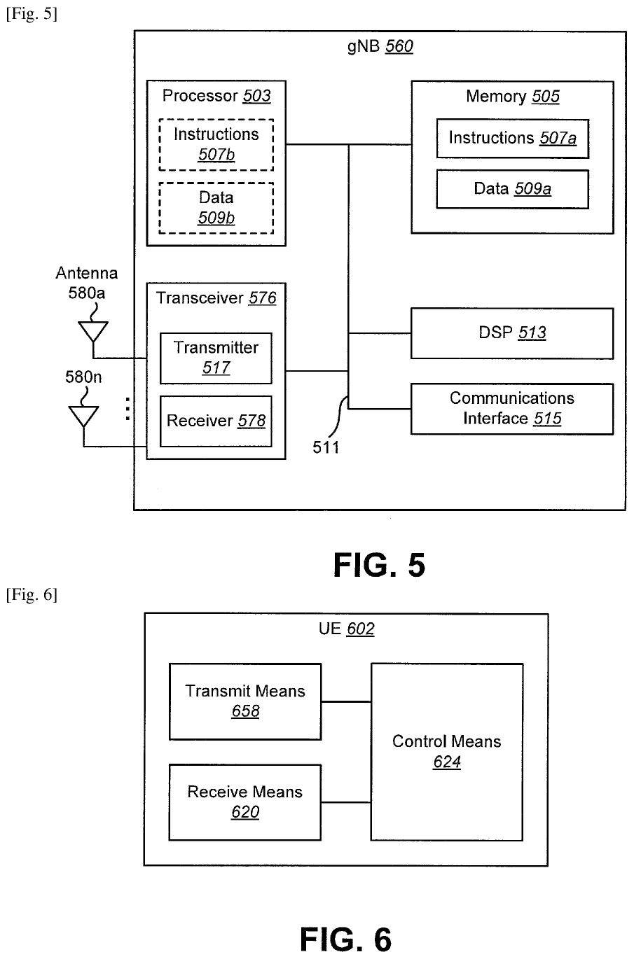

FIG. 5 illustrates various components that may be utilized in a gNB 560. The gNB 560 described in connection with FIG. 5 may be implemented in accordance with the gNB 160 described in connection with FIG. 1. In some examples, the gNB 560 may perform one or more of the methods, functions, operations, and/or examples, etc., described herein. The gNB 560 includes a processor 503 that controls operation of the gNB 560. The processor 503 may also be referred to as a central processing unit (CPU). Memory 505, which may include read-only memory (ROM), random access memory (RAM), a combination of the two or any type of device that may store information, provides instructions 507a and data 509a to the processor 503. A portion of the memory 505 may also include non-volatile random-access memory (NVRAM). Instructions 507b and data 509b may also reside in the processor 503. Instructions 507b and/or data 509b loaded into the processor 503 may also include instructions 507a and/or data 509a from memory 505 that were loaded for execution or processing by the processor 503. The instructions 507b may be executed by the processor 503 to implement the methods described above.

The gNB 560 may also include a housing that contains one or more transmitters 517 and one or more receivers 578 to allow transmission and reception of data. The transmitter(s) 517 and receiver(s) 578 may be combined into one or more transceivers 576. One or more antennas 580a-n are attached to the housing and electrically coupled to the transceiver 576.

The various components of the gNB 560 are coupled together by a bus system 511, which may include a power bus, a control signal bus, and a status signal bus, in addition to a data bus. However, for the sake of clarity, the various buses are illustrated in FIG. 5 as the bus system 511. The gNB 560 may also include a digital signal processor (DSP) 513 for use in processing signals. The gNB 560 may also include a communications interface 515 that provides user access to the functions of the gNB 560. The gNB 560 illustrated in FIG. 5 is a functional block diagram rather than a listing of specific components.

FIG. 6 is a block diagram illustrating one implementation of a UE 602 in which the systems and methods described herein may be implemented. The UE 602 includes transmit means 658, receive means 620 and control means 624. The transmit means 658, receive means 620 and control means 624 may be configured to perform one or more of the functions described in connection with FIG. 1 above. FIG. 4 above illustrates one example of a concrete apparatus structure of FIG. 6. Other various structures may be implemented to realize one or more of the functions of FIG. 1. For example, a DSP may be realized by software.

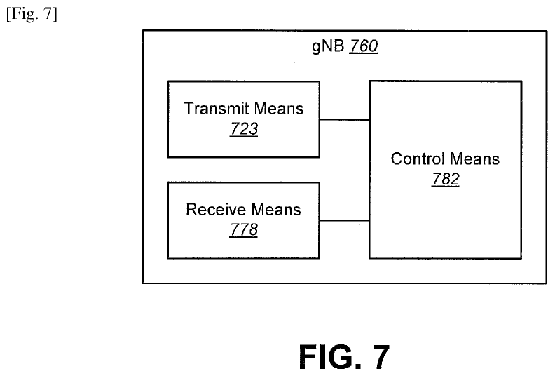

FIG. 7 is a block diagram illustrating one implementation of a gNB 760 in which the systems and methods described herein may be implemented. The gNB 760 includes transmit means 723, receive means 778 and control means 782. The transmit means 723, receive means 778 and control means 782 may be configured to perform one or more of the functions described in connection with FIG. 1 above. FIG. 5 above illustrates one example of a concrete apparatus structure of FIG. 7. Other various structures may be implemented to realize one or more of the functions of FIG. 1. For example, a DSP may be realized by software.

FIG. 8 is a flow diagram illustrating a method 800 by a UE for handling SR and PUSCH collision. For instance, FIG. 8 illustrates a problem that may occur with some approaches to handling SR and PUSCH collisions. The method 800 illustrates an example of SR and PUSCH collision handling when a PUCCH with a positive SR overlaps with a PUSCH. For example, a UE may determine 802 whether an SR and a PUSCH have the same priority. For instance, the UE may determine whether a priority index for the SR is the same as a priority index for the PUSCH.

In a case that the SR and the PUSCH have the same priority, the UE transmits 804 the PUSCH and does not transmit the PUCCH for the positive SR. Accordingly, the SR may be dropped. In this case, the base station may receive the PUSCH and does not receive the PUCCH for the positive SR.

In a case that the SR and PUSCH do not have the same priority, the UE may determine 806 whether the SR is configured with high priority. For instance, the UE may determine whether the priority index for the SR is 1 (indicating high priority, for instance). In a case that the SR is not configured with high priority, the UE may transmit 804 the PUSCH and may not transmit the PUCCH for the positive SR. In a case that the SR is configured with high priority, the UE transmits 808 the PUCCH for the positive HP SR and may cancel the transmission of the LP PUSCH. In this case, the base station may receive the PUCCH for the positive HP SR and does not receive the LP PUSCH.

As illustrated in FIG. 8, for overlapping between a PUCCH with a positive SR and a PUSCH with the same priority, the SR may be dropped and not reported. For overlapping between a PUCCH with a positive SR and a PUSCH with different priorities, the PUCCH or PUSCH with high priority or larger priority index may be transmitted, and the PUCCH or PUSCH with low priority or smaller priority index may be dropped.

Thus, for overlap between a PUCCH with a positive SR with low priority and a PUSCH with high priority, the PUCCH with low priority SR may be dropped and the high priority PUSCH may be transmitted. Similarly, for overlapping between a PUCCH with a positive SR with high priority and a PUSCH with low priority, the PUCCH with high priority SR has a higher priority and may be transmitted, and the PUSCH with low priority may be dropped. For example, if a UE 102 would transmit channels that would overlap in time between a first PUCCH of larger priority index with SR and a PUSCH of smaller priority index, the UE 102 is expected to cancel the PUSCH transmissions of smaller priority index before the first symbol overlapping with the PUCCH transmission of larger priority index.

In a case of PUSCH dropping by a HP PUCCH, the PUSCH transmission may be cancelled (e.g., cancelled at least) from the overlapping symbol with the HP PUCCH, and the PUSCH transmission may not be resumed after cancellation. If the transmission of the HP PUCCH is known before the starting symbol of the PUSCH, the PUSCH may be fully dropped without transmission.

FIG. 9 is a flow diagram illustrating another method 900 by a UE for handling SR and PUSCH collision. For instance, the method 900 may provide enhanced dropping behavior between SR and PUSCH. In some examples, the method 900 may be performed by the UE 102 described in relation to FIG. 1.

The method 900 illustrates an example of SR and PUSCH collision handling when a PUCCH with a positive HP SR overlaps with a LP PUSCH. For example, a UE may determine 902 whether UCI is multiplexed on the LP PUSCH. For instance, the UE may determine whether UCI (e.g., HARQ-ACK and/or SR) is multiplexed with other data on the LP PUSCH.

In a case that UCI is not multiplexed on the LP PUSCH, the UE transmits 904 the PUCCH for the positive HP SR and may cancel the transmission of the LP PUSCH. Accordingly, the LP PUSCH may be dropped. In this case, the base station may receive the PUCCH for the positive HP SR and may not receive the LP PUSCH.

In a case that UCI is multiplexed on the LP PUSCH, the UE may determine 906 whether at least a HP UCI is multiplexed on the LP PUSCH. For instance, the UE may determine whether the UCI that is multiplexed on the LP PUSCH includes a HP UCI (e.g., UCI with a priority index of 1). In a case that HP UCI is not multiplexed on the LP PUSCH, the UE may transmit 904 the PUCCH for the positive HP SR and may cancel the transmission of the LP PUSCH. In a case that at least a HP UCI is multiplexed on the LP PUSCH, the UE may transmit 908 the PUSCH with HP UCI, and may not transmit the PUCCH for the positive HP SR. In this case, the base station may receive the PUCCH with the HP UCI, and may not receive the PUCCH for the positive HP SR.

As illustrated in FIG. 9, in a case of a PUCCH where a positive HP SR overlaps with a LP PUSCH, if there is no UCI or only LP UCI is multiplexed on the PUSCH, previous dropping behavior may be used in some examples. Accordingly, the LP PUSCH may be dropped, and the HP SR PUCCH may be transmitted. In this case, the LP PUSCH may be a PUSCH with or without data, and with or without other UCIs such as a LP HARQ-ACK or a CSI, etc. If the LP PUSCH is dropped, the UCI multiplexed on the LP PUSCH (e.g., LP HARQ-ACK and/or CSI) may also be dropped and may not be received by the base station (e.g., gNB).

In case of a PUCCH where a positive HP SR overlaps with a LP PUSCH, and if there is at least a high priority UCI (e.g., a HP HARQ-ACK) multiplexed on the LP PUSCH, the LP PUSCH may be treated as a HP PUSCH. Accordingly, the HP SR may be dropped and the PUCCH for the positive SR with high priority may not be transmitted. The LP PUSCH may be transmitted. In some examples, the LP PUSCH may include other UCI besides the HP UCI (e.g., a LP HARQ-ACK and/or CSI).

In a case of PUSCH dropping, in some examples, the PUSCH transmission may be cancelled at least from the overlapping symbol with the HP PUCCH for the positive HP SR, and the PUSCH transmission may not be resumed after cancellation. If the positive HP SR status is known before the starting symbol of the PUSCH, the PUSCH may be fully dropped without transmission.

Some of the techniques for enhanced channel dropping may provide one or more benefits. For example, some of the techniques may provide to differentiate a LP PUSCH by the UCI multiplexed on the LP PUSCH. In some examples, some of the techniques may avoid dropping HP UCI multiplexed on a LP PUSCH.

FIG. 10 is a flow diagram illustrating a method 1000 by a UE for reporting both LP UCI on PUSCH and HP SR in overlapping conditions. In some examples, the method 1000 may be performed by the UE 102 (e.g., UE operations module 124, UE scheduling module 126, etc.) described in relation to FIG. 1. In some examples, the method 1000 may be performed if the LP UCI on PUSCH includes only a LP HARQ-ACK or only a CSI report.

The method 1000 illustrates an example where a PUCCH with a positive HP SR overlaps with a LP PUSCH multiplexed with LP UCI only. For example, a UE may determine 1002 whether a PUCCH for the positive HP SR overlaps with the PUSCH symbols carrying the LP UCI and/or the corresponding DMRS.

In a case that the PUCCH for the positive HP SR does not overlap with the PUSCH symbols carrying the LP UCI and/or the corresponding DMRS, the UE may transmit 1004 the PUCCH for the positive HP SR and may transmit a punctured PUSCH with all symbols carrying the LP UCI and the corresponding DMRS. In this case, the base station may receive the PUCCH for the positive HP SR and may receive a punctured PUSCH with all symbols carrying the LP UCI and the corresponding DMRS.

In a case that the PUCCH for the positive HP SR overlaps with the PUSCH symbols carrying the LP UCI and/or the corresponding DMRS, the UE may transmit 1006 the PUCCH for the positive HP SR and may cancel the transmission of the LP PUSCH.

As illustrated in FIG. 10, if the PUCCH for the positive HP SR does not overlap with the PUSCH symbols carrying the multiplexed LP UCI (e.g., LP HARQ-ACK information), and does not overlap with the corresponding DMRS for the UCI carrying symbols, the HP SR PUCCH may be transmitted, and the PUSCH with the LP UCI may be punctured (e.g., at least the overlapping symbols with the PUCCH for the HP SR). symbols carrying the LP UCI and the corresponding DMRS in the PUSCH may still be transmitted. In this case, both the LP UCI on PUSCH and the positive HP SR may be reported to the gNB 160.

Otherwise, if the PUCCH for the positive HP SR overlaps with the PUSCH symbols carrying the multiplexed LP UCI, (e.g., LP HARQ-ACK information) and/or overlaps with the corresponding DMRS for the UCI carrying symbols, the HP SR PUCCH may be transmitted, and the PUSCH with the LP UCI may be cancelled at least from the overlapping symbol. The PUSCH may not be resumed after it is cancelled.

FIG. 11 is a flow diagram illustrating a method 1100 by a UE for reporting multiple LP UCIs on PUSCH and HP SR by overlapping conditions. In some examples, the method 1100 may be performed by the UE 102 described in relation to FIG. 1.

The method 1100 illustrates an example of SR and PUSCH collision handling when a PUCCH with a positive HP SR overlaps with a LP PUSCH multiplexed with LP UCI only, including both LP HARQ-ACK and CSI. For example, a UE may determine 1102 whether a PUCCH for the positive HP SR overlaps with the PUSCH symbols carrying the LP UCIs and/or the corresponding DMRS.

In a case that the PUCCH for the positive HP SR does not overlap with the PUSCH symbols carrying the LP UCIs and/or the corresponding DMRS, the UE may transmit 1104 the PUCCH for the positive HP SR and may transmit a punctured PUSCH with all symbols carrying the LP UCIs and the corresponding DMRS. In this case, the base station may receive the PUCCH for the positive HP SR and may receive the punctured PUSCH with all symbols carrying the LP UCIs and the corresponding DMRS.

In a case that the PUCCH for the positive HP SR overlaps with the PUSCH symbols carrying the LP UCIs and/or the corresponding DMRS, the UE may determine 1106 whether the PUCCH for the positive HP SR overlaps with the PUSCH symbols carrying the LP HARQ-ACK and/or the corresponding DMRS. In a case that the PUCCH for the positive HP SR does not overlap with the PUSCH symbols carrying the LP HARQ-ACK and/or the corresponding DMRS, the UE may transmit 1108 the PUCCH for the positive HP SR and may transmit a punctured PUSCH with all symbols carrying the LP HARQ-ACK and the corresponding DMRS. In a case that the PUCCH for the positive HP SR overlaps with the PUSCH symbols carrying the LP HARQ-ACK and/or the corresponding DMRS, the UE may transmit 1110 the PUCCH for the positive HP SR and may cancel the transmission of the LP PUSCH. In this case, the base station may receive the PUCCH for the positive HP SR and may not receive the LP PUSCH.

As illustrated in FIG. 11, if the PUCCH for the positive HP SR does not overlap with the PUSCH symbols carrying the multiplexed LP UCIs including HARQ-ACK and CSI, and does not overlap with the corresponding DMRS for the UCI carrying symbols, the HP SR PUCCH is transmitted, and the PUSCH with the LP UCI is punctured for at least the overlapping symbols with the PUCCH for the HP SR. In this approach, all symbols carrying the LP UCIs and the corresponding DMRSs in the PUSCH may still be transmitted. In this approach, both the LP UCIs (including LP HARQ-ACK and CSI) on the PUSCH and the positive HP SR may be reported to the gNB (e.g., gNB 160).

If the PUCCH for the positive HP SR overlaps with the PUSCH symbols carrying the multiplexed LP UCIs including HARQ-ACK and CSI and/or overlaps with the corresponding DMRS for the UCI carrying symbols, the overlapping conditions may be further evaluated based on the symbol carrying LP HARQ-ACK information only.

If the PUCCH for the positive HP SR does not overlap with the PUSCH symbols carrying the multiplexed LP HARQ-ACK information, and does not overlap with the corresponding DMRS for the UCI carrying symbols, the HP SR PUCCH is transmitted, and the PUSCH with the LP UCIs is punctured on at least the overlapping symbols with the PUCCH for the HP SR. All symbols carrying the LP HARQ-ACK and the corresponding DMRS in the PUSCH may still be transmitted. In this case, both the LP HARQ-ACK on PUSCH and the positive HP SR may be reported to the gNB (e.g., gNB 160).

If the PUCCH for the positive HP SR overlaps with the PUSCH symbols carrying the multiplexed LP HARQ-ACK and/or overlaps with the corresponding DMRS for the LP HARQ-ACK carrying symbols, the HP SR PUCCH may be transmitted, and the PUSCH with the LP UCIs may be cancelled at least from the overlapping symbol. The PUSCH may not be resumed after it is cancelled.

FIG. 12 is a flow diagram illustrating a method 1200 by a UE for reporting both HP UCI on a PUSCH and HP SR by overlapping conditions. In some examples, the method 1200 may be performed by the UE 102 (e.g., UE operations module 124, UE scheduling module 126, etc.) described in relation to FIG. 1.

The method 1200 illustrates an example of SR and PUSCH collision handling when a PUCCH with a positive HP SR overlaps with a LP PUSCH. For example, a UE may determine 1202 whether at least a HP UCI is multiplexed on the LP PUSCH. In a case that at least a HP UCI is not multiplexed on the LP PUSCH, the UE may transmit 1204 the PUCCH for the positive HP SR and may cancel the transmission of the LP PUSCH.

In a case that at least a HP UCI is multiplexed on the LP PUSCH, the UE may determine 1206 whether the PUCCH for the positive HP SR overlaps with the PUSCH symbols carrying the multiplexed HP UCI and/or the corresponding DMRS. In a case that the PUCCH for the positive HP SR does not overlap with the PUSCH symbols carrying the multiplexed HP UCI and/or the corresponding DMRS, the UE may transmit 1208 the PUCCH for the positive HP SR and may transmit a punctured PUSCH with all symbols carrying the HP UCI and the corresponding DMRS. In this case, the base station may receive the PUCCH, and may receive the punctured PUSCH. In a case that the PUCCH for the positive HP SR overlaps with the PUSCH symbols carrying the multiplexed HP UCI and/or the corresponding DMRS, the UE may transmit 1210 the PUSCH with HP UCI, and may not transmit the PUCCH for the positive HP SR. In this case, the base station may receive the PUSCH with HP UCI, and may not receive the PUCCH for the positive HP SR.

In some examples, if the PUCCH for the positive HP SR does not overlap with the PUSCH symbols carrying the multiplexed HP UCI (e.g., HP HARQ-ACK) and/or the corresponding DMRS, the HP SR PUCCH is transmitted, and the PUSCH with the HP UCI is punctured for at least the overlapping symbols with the PUCCH for the HP SR. All symbols carrying the HP UCI and the corresponding DMRS in the PUSCH may be transmitted. In this approach, both the HP UCI on PUSCH and the positive HP SR may be reported to the gNB (e.g., gNB 160).

Otherwise, if the PUCCH for the positive HP SR overlaps with the PUSCH symbols carrying the multiplexed HP UCI (e.g., HP HARQ-ACK information) and/or overlaps with the corresponding DMRS for the UCI carrying symbols, the HP SR may be dropped, and the PUSCH with the HP UCI is transmitted.

FIG. 13 is a flow diagram illustrating a method 1300 by a UE for reporting both HP and LP UCI on a PUSCH and HP SR by overlapping conditions. In some examples, the method 1300 may be performed by the UE 102 (e.g., UE operations module 124, UE scheduling module 126, etc.) described in relation to FIG. 1.

The method 1300 illustrates an example of SR and PUSCH collision handling when a LP PUSCH multiplexed with both HP UCI and LP UCI. For example, a UE may determine 1302 whether a PUCCH for the positive HP SR overlaps with the PUSCH symbols carrying HP and LP UCIs and/or the corresponding DMRS. In a case that the PUCCH for the positive HP SR does not overlap with the PUSCH symbols carrying HP and LP UCIs and/or the corresponding DMRS, the UE may transmit 1304 the PUCCH for the positive HP SR and may transmit a punctured PUSCH with all symbols carrying the HP UCI and LP UCI, and the corresponding DMRS.

In a case that the PUCCH for the positive HP SR overlaps with the PUSCH symbols carrying HP and LP UCIs and/or the corresponding DMRS, the UE may determine 1306 whether the PUCCH for the positive HP SR overlaps with the PUSCH symbols carrying HP HARQ-ACK and LP HARQ-ACK and/or the corresponding DMRS. In a case that the PUCCH for the positive HP SR does not overlap with the PUSCH symbols carrying HP HARQ-ACK and LP HARQ-ACK and/or the corresponding DMRS, the UE may transmit 1308 the PUCCH for the positive HP SR and may transmit a punctured PUSCH with all symbols carrying the HP HARQ-ACK and LP HARQ-ACK, and the corresponding DMRS. In this case, the base station (e.g., gNB 160) may receive the PUCCH, and may receive the punctured PUSCH. In a case that the PUCCH for the positive HP SR overlaps with the PUSCH symbols carrying HP HARQ-ACK and LP HARQ-ACK and/or the corresponding DMRS, the UE may determine 1310 whether the PUCCH for the positive HP SR overlaps with the PUSCH symbols carrying HP HARQ-ACK and/or the corresponding DMRS.

In a case that the PUCCH for the positive HP SR does not overlap with the PUSCH symbols carrying HP HARQ-ACK and/or the corresponding DMRS, the UE may transmit 1312 the PUCCH for the positive HP SR and may transmit a punctured PUSCH with all symbols carrying the HP UCI and the corresponding DMRS. In a case that the PUCCH for the positive HP SR overlaps with the PUSCH symbols carrying HP HARQ-ACK and/or the corresponding DMRS, the UE may transmit 1314 the PUSCH with HP UCI, and may not transmit the PUCCH for the positive HP SR. In this case, the base station may receive the PUSCH with HP UCI, and may not receive the PUCCH for the positive HP SR.

In some examples, if the PUCCH for the positive HP SR does not overlap with the PUSCH symbols carrying the multiplexed HP and LP UCIs, the HP SR PUCCH may be transmitted, and the PUSCH may be punctured for at least the overlapping symbols with the PUCCH for the HP SR. All symbols carrying the HP and LP UCIs and the corresponding DMRSs in the PUSCH may be transmitted. In this case, both the HP and LP UCIs (including HP HARQ-ACK and LP HARQ-ACK, and CSI if present, for instance) on the PUSCH and the positive HP SR may be reported to the gNB (e.g., gNB 160). If the PUCCH for the positive HP SR overlaps with the PUSCH symbols carrying the multiplexed HP and LP UCIs and/or overlaps with the corresponding DMRS for the UCI carrying symbols, and if the CSI is included in the UCI, the overlapping conditions may be further evaluated based on the symbol carrying HARQ-ACK only, including both HP HARQ-ACK and LP HARQ-ACK.

If the PUCCH for the positive HP SR does not overlap with the PUSCH symbols carrying the multiplexed HP HARQ-ACK and LP HARQ-ACK, the HP SR PUCCH may be transmitted, and the PUSCH may be punctured for at least the overlapping symbols with the PUCCH for the HP SR. All symbols carrying the HP HARQ-ACK and LP HARQ-ACK and the corresponding DMRSs in the PUSCH may be transmitted. In this case, both the HP HARQ-ACK and LP HARQ-ACK on PUSCH and the positive HP SR may be reported to the gNB (e.g., gNB 160).

If the PUCCH for the positive HP SR overlaps with the PUSCH symbols carrying the multiplexed HP HARQ-ACK and LP HARQ-ACK, and/or overlaps with the corresponding DMRS for the HARQ-ACK carrying symbols, the overlapping conditions may be further evaluated based on the symbol carrying HP UCI (e.g., HP HARQ-ACK information only).

If the PUCCH for the positive HP SR does not overlap with the PUSCH symbols carrying the multiplexed HP HARQ-ACK information, the HP SR PUCCH may be transmitted, and the PUSCH may be punctured for at least the overlapping symbols with the PUCCH for the HP SR. All symbols carrying the HP HARQ-ACK and the corresponding DMRS in the PUSCH may be transmitted. In this case, both the HP HARQ-ACK on PUSCH and the positive HP SR may be reported to the gNB (e.g., gNB 160).

If the PUCCH for the positive HP SR overlaps with the PUSCH symbols carrying the multiplexed HP HARQ-ACK and/or overlaps with the corresponding DMRS, the HP SR may be dropped, and the PUSCH with all multiplexed UCIs may be transmitted.

FIG. 14A is a diagram illustrating a first example of puncturing in accordance with some of the techniques described herein. In some examples, only the overlapping symbols between the LP PUSCH and the PUCCH for HP SR may be punctured. Thus, if there are remaining symbols after the overlapping region, the PUSCH transmission may be resumed, as illustrated in FIG. 14A.

FIG. 14B is a diagram illustrating a second example of puncturing in accordance with some of the techniques described herein. In this example, the PUSCH transmission may be resumed if the LP UCI is multiplexed in two hops in case of frequency hopping is configured, and the overlapping symbols are between the LP UCI carrying symbols, as shown in FIG. 14B. In some examples, the HP UCI may be multiplexed on one hop only on PUSCH.

FIG. 14C is a diagram illustrating a third example of puncturing in accordance with some of the techniques described herein. For instance, the puncturing is performed from the first overlapping symbol between the LP PUSCH and the PUCCH for HP SR, and the LP PUSCH transmission may not be resumed, as shown in FIG. 14C. Thus, there may be remaining symbols after the overlapping region but no remaining symbol carrying the UCI. With this approach, if frequency hopping is configured, and the UCI is multiplexed in both hops, all symbols between the two segments of UCI symbols may be treated as UCI carrying symbols for overlapping evaluation.

FIG. 14D is a diagram illustrating a fourth example of puncturing in accordance with some of the techniques described herein. For instance, the puncturing may happen immediately after the last PUSCH symbol carrying the multiplexed UCI (e.g., the HARQ-ACK), as shown in FIG. 14D.

FIG. 14E is a diagram illustrating a fifth example of puncturing in accordance with some of the techniques described herein. For instance, the PUSCH may be punctured by keeping only the DMRS symbols and the symbols with multiplexed UCI (e.g., the HARQ-ACK), as shown in FIG. 14E. FIGS. 14A-D may provide examples of PUSCH dropping approaches by PUCCH with positive HP SR.

Some examples of the techniques described herein may provide benefits of dropping methods with potential simultaneous SR PUCCH and UCI reporting on PUSCH. In some examples, it may be beneficial to report both a HP positive SR and the UCI multiplexed on a LP PUSCH, the UCI on PUSCH may be HP HARQ-ACK and/or LP HARQ-ACK and/or CSI. In some examples, in case of multiple UCIs multiplexed on a LP PUSCH, iterative steps may be used to report as many UCIs as possible.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. A user equipment (UE), comprising:
transmitting circuitry configured to report a high-priority positive scheduling request (SR) and uplink control information (UCI) multiplexed on a physical uplink shared channel (PUSCH) based on an overlapping condition.

2. The UE of claim 1, wherein a channel dropping procedure with potential simultaneous SR physical uplink control channel (PUCCH) and UCI reporting on the PUSCH is a feature of the UE.

3. The UE of claim 2, wherein the feature is supported based on UE capability and is configured by a base station via higher-layer signaling.

4. The UE of claim 1, further comprising a processor configured to evaluate the overlapping condition between the UCI multiplexed on the PUSCH and a physical uplink control channel (PUCCH) for a position of the high-priority SR, and to determine whether or not to report UCI together with the high-priority SR.

5. The UE of claim 4, wherein the evaluation is performed in several steps for all UCIs to reduce or minimize dropping of UCI multiplexed on a low-priority PUSCH.

6. The UE of claim 4, wherein the evaluation is performed only for hybrid automatic repeat request-acknowledgement (HARQ-ACKs).

7. The UE of claim 6, wherein the HARQ-ACKs comprise at least one of high-priority HARQ-ACK and low-priority HARQ-ACK multiplexed on a low-priority PUSCH.

8. The UE of claim 4, wherein the evaluation is performed only for high-priority hybrid automatic repeat request-acknowledgement (HARQ-ACK) multiplexed on a low-priority PUSCH.

9. The UE of claim 1, wherein if there is UCI multiplexed on a low-priority PUSCH, whether a UCI multiplexed on the PUSCH can be reported simultaneously with a high-priority SR physical uplink control channel (PUCCH) is determined based whether a high-priority SR PUCCH resource overlaps with any of UCI carrying symbols or a corresponding demodulation reference signal (DMRS) for the UCI carrying symbols.

10. The UE of claim 9, wherein if there is overlapping, simultaneous reporting is not performed for the UCI and channel dropping rules based on multiplexed UCI priority are applied.

11. The UE of claim 9, wherein if there is no overlapping, the UCI is reported together with the SR.

12. A base station (gNB), comprising:
transmitting circuitry configured to transmit higher-layer signaling to a user equipment (UE), wherein the higher-layer signaling indicates a configuration of a channel dropping procedure with potential simultaneous SR physical uplink control channel (PUCCH) and UCI reporting on the PUSCH.

13. A method by a user equipment (UE), comprising:
reporting a high-priority positive scheduling request (SR) and uplink control information (UCI) multiplexed on a physical uplink shared channel (PUSCH) based on an overlapping condition.
